(19) United States
(12) Patent Application Publication
(10) Pub. No.: US 2023/0411848 A1
(43) Pub. Date: Dec. 21, 2023

(54) ANTENNA, WIRELESS COMMUNICATION MODULE, AND WIRELESS COMMUNICATION DEVICE

(71) Applicant: KYOCERA CORPORATION, Kyoto-shi, Kyoto (JP)

(72) Inventor: Hiromichi YOSHIKAWA, Yokohama-shi, Kanagawa (JP)

(21) Appl. No.: 18/040,153

(22) PCT Filed: Jul. 26, 2021
(86) PCT No.: PCT/JP2021/027602

§ 371 Date: Jul. 10, 2023

(30) Foreign Application Priority Data
Aug. 3, 2020 (JP) 2020-131661

(51) Int. Cl. H01Q 5/35; H01Q 9/04

(52) U.S. Cl. CPC H01Q 5/35; H01Q 9/0457

(57) ABSTRACT

An antenna includes a base, a patch conductor, a peripheral conductor surrounding the patch conductor, a first predetermined number of coupling conductors capacitively connecting the patch conductor and the peripheral conductor, the first predetermined number being at least three, and a first power feed line connected to the patch conductor. Among the first predetermined number of coupling conductors, any two form a first coupling pair composing a part of a first coupling group aligned in a first direction along a first plane, and any two form a second coupling pair composing a part of a second coupling group arranged in a second direction intersecting the first direction along the first plane. The antenna is configured to resonate in a first frequency band along a first electrical current path, and is configured to resonate in a second frequency band along a second electrical current path.

### RELATED APPLICATIONS

The present application is a National Phase of International Application Number PCT/JP2021/027602 filed Jul. 26, 2021, which claims the benefit of priority from Japanese Patent Application No. 2020-131661, filed on Aug. 3, 2020.

### TECHNICAL FIELD

The present disclosure relates to an antenna, a wireless communication module, and a wireless communication device.

### BACKGROUND OF INVENTION

A circular polarized antenna using a power supply scheme for capacitive coupling is known. For example, a circular polarized antenna that achieves compactness, thinness, and high performance without increasing cost has been disclosed.

### CITATION LIST

### Patent Literature

Patent Document 1: JP 2010-136296 A

### SUMMARY

### Problem to be Solved

In the circular polarized antenna disclosed in Patent Document 1, a radiation electrode is formed on the upper surface of a substrate, and a ground electrode is formed on the entire lower surface of the substrate. When the ground electrode is formed on the entire lower surface of the substrate, further thinning may not be achieved.

It is an object of the present disclosure to provide an antenna, a wireless communication module, and a wireless communication device which can reduce the thickness of the whole device.

### Solution to Problem

In one aspect of the present disclosure, an antenna includes a base having a first surface extending along a first plane, a patch conductor disposed on the first surface, a peripheral conductor disposed on the first surface and surrounding the patch conductor, a first predetermined number of coupling conductors capacitively connecting the patch conductor and the peripheral conductor, the first predetermined number being at least three, and a first power feed line connected to the patch conductor, in which among the first predetermined number of coupling conductors, any two of the coupling conductors form a first coupling pair composing a part of a first coupling group aligned in a first direction along the first plane, and any two of the coupling conductors form a second coupling pair composing a part of a second coupling group aligned in a second direction intersecting the first direction along the first plane, the antenna is configured to resonate in a first frequency band along a first electrical current path, and is configured to resonate in a second frequency band along a second electrical current path, the first electrical current path includes the patch conductor, the peripheral conductor, and the first coupling pair, and the second electrical current path includes the patch conductor, the peripheral conductor, and the second coupling pair.

In another aspect of the present disclosure, a wireless communication module includes the antenna according to the one aspect of the present disclosure and an RF module configured to be electrically connected to the first power feed line.

In still another aspect of the present disclosure, a wireless communication device includes the wireless communication module according to the other aspect of the present disclosure, and a battery configured to supply power to the wireless communication module.

### Advantageous Effect

The present disclosure can reduce the thickness of the whole device.

### BRIEF DESCRIPTION OF THE DRAWINGS

FIG. 1 is a schematic view of an antenna according to an embodiment, when viewed from above.

FIG. 2 is a schematic view of the antenna according to the embodiment, when viewed from below.

FIG. 3 is an exploded schematic view of a part of the antenna according to the embodiment.

FIG. 4 is a view for explaining a first resonant state of the antenna according to the embodiment.

FIG. 5 is a view for explaining a second resonant state of the antenna according to the embodiment.

FIG. 6 is a view for explaining radiation characteristics of the antenna in the azimuth direction and the elevation direction according to the embodiment.

FIG. 7 is a graph for explaining the axial ratio in the elevation direction of the antenna according to the embodiment.

FIG. 8 is a schematic view of an antenna according to a first variation of the embodiment, when viewed from above.

FIG. 9 is a schematic view of the antenna according to the first variation of the embodiment, when viewed from below.

FIG. 10 is a schematic view of an antenna according to a second variation of the embodiment, when viewed from above.

FIG. 11 is a schematic view of the antenna according to the second variation of the embodiment, when viewed from below.

FIG. 12 is a block diagram illustrating an example structure of a wireless communication module according to the embodiment.

FIG. 13 is a block diagram illustrating an example structure of a wireless communication device according to the embodiment.

In the following, an embodiment of the present disclosure will be described in detail with reference to the accompanying drawings. The present disclosure is not limited by the embodiment, and when more than one embodiment is provided, a combination of such embodiments is also included in the present disclosure. In the embodiment described below, the same reference signs are given to the same portions, and the description thereof will be omitted.

In the following description, a three-dimensional orthogonal coordinate system is set, and the positional relationship of respective portions will be described by referring to the three-dimensional orthogonal coordinate system. The direction parallel to the X-axis in a predetermined plane is defined as the X axis direction, the direction parallel to the Y-axis that is orthogonal to the X-axis in the predetermined plane is defined as the Y axis direction, and the direction parallel to the Z-axis that is orthogonal to the X- and Y-axes is defined as the Z axis direction.

### EMBODIMENT

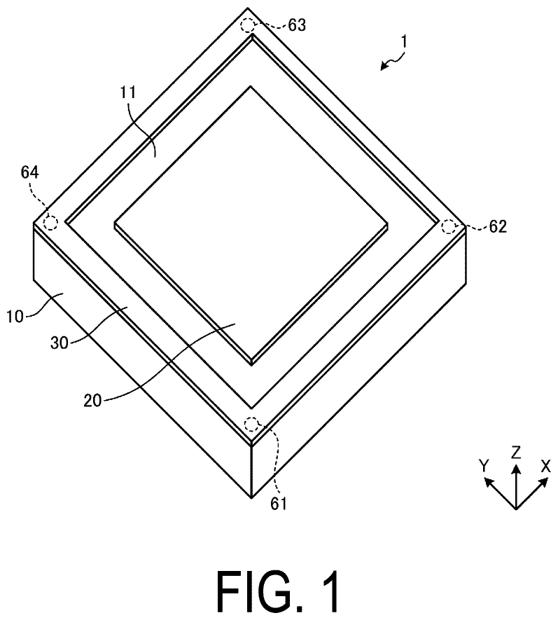

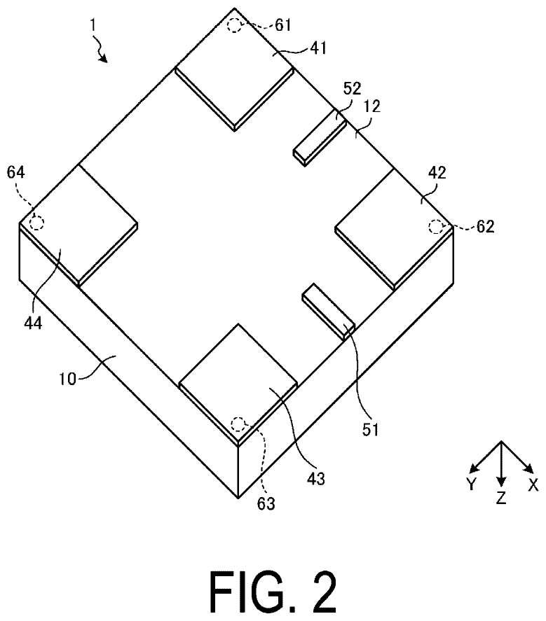

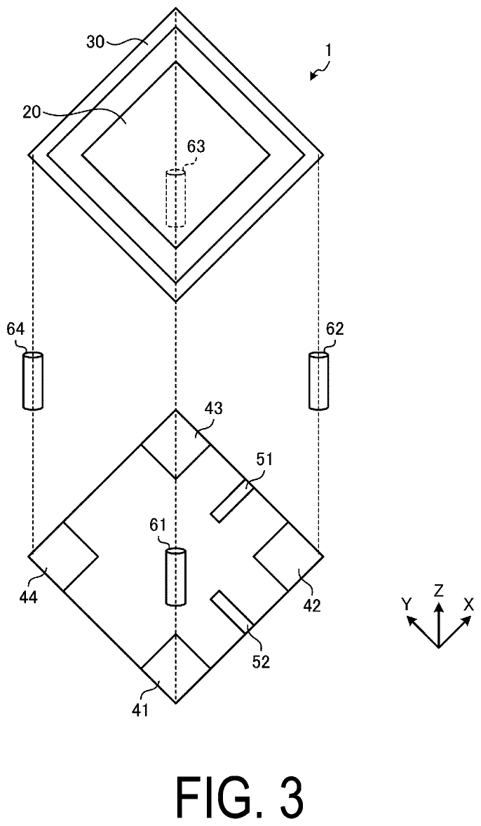

An example structure of an antenna according to an embodiment is described with reference to FIGS. 1, 2, and 3. FIG. 1 is a schematic view of the antenna according to the embodiment, when viewed from above. FIG. 2 is a schematic view of the antenna according to the embodiment, when viewed from below. FIG. 3 is an exploded schematic view of a portion of the antenna according to the embodiment.

As illustrated in FIGS. 1 and 2, the antenna 1 includes a base 10, a patch conductor 20, a peripheral conductor 30, a first coupling conductor 41, a second coupling conductor 42, a third coupling conductor 43, a fourth coupling conductor 44, a first power feed line 51, and a second power feed line 52. The antenna 1 includes a first connection conductor 61, a second connection conductor 62, a third connection conductor 63, and a fourth connection conductor 64. The antenna 1 resonates at one or more predetermined resonant frequencies. The antenna 1 is, for example, a thin antenna having a length in the X axis direction of 50 millimeters (mm), a length in the Y axis direction of 50 mm, and a length in the Z axis direction of 0.5 mm.

The base 10 can be made of a dielectric material. The base 10 includes an upper surface 11 extending along a first plane and a lower surface 12 facing the upper surface 11. The first plane can be, for example, the XY plane. The upper surface 11 of the base 10 is also referred to as a first surface. The lower surface 12 of the base 10 is also referred to as a second surface. The base 10 can have a shape corresponding to the patch conductor 20. For example, when the patch conductor 20 has a substantially square shape, the base 10 can have a substantially square column shape. The relative permittivity of the base 10 can be adjusted as appropriate in accordance with the desired resonant frequency of the antenna 1.

The patch conductor 20 can be made of an electrically conductive material. The patch conductor 20 is formed on the upper surface 11 of the base 10. The patch conductor 20 has a shape extending over the upper surface 11. The patch conductor 20 has, for example, a substantially square shape. The patch conductor 20 may have different lengths in the X axis direction and in the Y axis direction. That is, the patch conductor 20 may have a substantially rectangular shape.

The patch conductor 20 operates as a part of a resonator.

The peripheral conductor 30 can be made of an electrically conductive material. The peripheral conductor 30 is disposed on the upper surface 11 of the base 10. The peripheral conductor 30 surrounds the patch conductor 20. The peripheral conductor 30 can be made of, for example, a frame that follows the shape of the patch conductor 20. The peripheral conductor 30 can be made of, for example, a substantially square-shaped frame formed along each side of the upper surface 11 of the base 10. The peripheral conductor 30 can function as the ground for the antenna 1.

A gap is formed between the patch conductor 20 and the peripheral conductor 30. The patch conductor 20 is capacitively connected to the peripheral conductor 30. The value of the capacitance generated between the patch conductor 20 and the peripheral conductor 30 changes depending on the size of the gap, a medium in the gap, and the facing areas. The size of the gap and the facing areas of the patch conductor 20 and the peripheral conductor 30 may be adjusted as appropriate depending on a desired resonant frequency of the antenna 1. The medium in the gap between the patch conductor 20 and the peripheral conductor 30 may be adjusted in accordance with the desired resonant frequency of the antenna 1. A capacitor may be provided to connect the patch conductor 20 and the peripheral conductor 30. The capacitance of the capacitor may be adjusted as appropriate in accordance with the desired resonant frequency of the antenna 1.

The first coupling conductor 41, the second coupling conductor 42, the third coupling conductor 43, and the fourth coupling conductor 44 may be made of electrically conductive materials. The first coupling conductor 41, the second coupling conductor 42, the third coupling conductor 43, and the fourth coupling conductor 44 are each capacitively connected to the patch conductor 20 and the peripheral conductor 30. The first coupling conductor 41, the second coupling conductor 42, the third coupling conductor 43, and the fourth coupling conductor 44 are each formed at different corners of the lower surface 12 of the base 10. The first coupling conductor 41, the second coupling conductor 42, the third coupling conductor 43, and the fourth coupling conductor 44 may be referred to collectively as coupling conductors 40 when no distinction is necessary.

The coupling conductors 40 can have substantially square shapes, for example. Each of the coupling conductors 40 can be shaped differently from each other. The first coupling conductor 41, the second coupling conductor 42, the third coupling conductor 43, and the fourth coupling conductor 44 are smaller than the patch conductor 20.

The antenna 1 includes four coupling conductors 40 including the first coupling conductor 41, the second coupling conductor 42, the third coupling conductor 43, and the fourth coupling conductor, but the present disclosure is not limited thereto. The antenna 1 needs to have a first predetermined number of coupling conductors 40. The first predetermined number is, for example, at least three.

The first coupling conductor 41 and the second coupling conductor 42 are part of a first group aligned in a first direction along the XY plane. The first direction can be the X axis direction. The first coupling conductor 41 and the second coupling conductor 42 form a first coupling pair. The third coupling conductor 43 and the fourth coupling conductor 44 are part of the first group aligned in the first direction along the XY plane. The third coupling conductor 43 and the fourth coupling conductor 44 form another first coupling pair different from the first coupling pair of the first coupling conductor 41 and the second coupling conductor 42.

The second coupling conductor 42 and the third coupling conductor 43 are part of a second group aligned in a second direction along the XY plane. The second direction can be, for example, the Y axis direction. The second coupling conductor 42 and the third coupling conductor 43 form a second coupling pair. The first coupling conductor 41 and the fourth coupling conductor 44 are part of the second group aligned in the second direction along the XY plane. The first coupling conductor 41 and the fourth coupling conductor 44 form another second coupling pair different from the second coupling pair of the second coupling conductor 42 and the third coupling conductor 43.

Each of the coupling conductors 40 can be paired with another coupling conductor 40 and belong to both the first and second groups. For example, the first coupling conductor 41 can be paired with the second coupling conductor 42 and become part of the first group aligned in the first direction along the XY plane. The first coupling conductor 41 can be paired with the fourth coupling conductor 44 and become part of the second group aligned in the second direction along the XY plane.

The first conductor 41 is electrically connected to the peripheral conductor 30 via the first coupling conductor 61. The second coupling conductor 42 is electrically connected to the peripheral conductor 30 via the second connection conductor 62. The third coupling conductor 43 is electrically connected to the peripheral conductor 30 via the third connection conductor 63. The fourth coupling conductor 44 is electrically connected to the peripheral conductor 30 via the fourth connection conductor 64. The first connection conductor 61, the second connection conductor 62, the third connection conductor 63, and the fourth connection conductor 64 can be through-hole conductors.

The first to fourth coupling conductors 41 to 44 can be capacitively connected to the patch conductor 20. Specifically, the first to fourth coupling conductors 41 to 44 can face the patch conductor 20 in a direction intersecting the XY plane and be capacitively connected to the patch conductor 20. More specifically, the first to fourth coupling conductors 41 to 44 can face the patch conductor 20 in the Z direction intersecting the XY plane and be capacitively connected to the patch conductor 20. The value of the capacitance generated between the patch conductor 20 and the coupling conductors 40 changes depending on a distance between the patch conductor 20 and the coupling conductors 40, that is, a length in the Z axis direction of the base 10. The length in the Z axis direction of the base 10 may be adjusted in accordance with a desired resonant frequency of the antenna 1.

The first power feed line 51 can be made of an electrically conductive material. The first power feed line 51 can be located between the second coupling conductor 42 and the third coupling conductor 43 in the Y direction on the lower surface 12 of the base 10. For example, the first power feed line 51 is electromagnetically connected at one end to the patch conductor 20 via a through-hole conductor. In the present disclosure, “electromagnetically connected” may indicate electrical connection or magnetic connection. The first power feed line 51 is electrically connected to the patch conductor 20 so that one end thereof is along the X direction of the XY plane. The other end of the first power feed line 51 can be connected to an external device or the like.

The first power feed line 51 feeds power to the patch conductor 20 from the +X direction side when the antenna 1 transmits radio waves to the outside. Feeding power to the patch conductor 20 from the first power feed line 51 is referred to as zero degree input. The first power feed line 51 feeds power from the patch conductor 20 to the external device or the like when the antenna 1 receives radio waves from the outside.

The second power feed line 52 can be made of an electrically conductive material. The second power feed line 52 can be located between the first coupling conductor 41 and the second coupling conductor 42 in the X direction on the lower surface 12 of the base 10. For example, the second power feed line 52 is electromagnetically connected at one end to the patch conductor 20 via a hole conductor. The second power feed line 52 is electrically connected to the patch conductor 20 so that one end thereof is along the Y direction of the XY plane. The other end of the second power feed line 52 can be connected to an external device or the like.

The second power feed line 52 feeds power to the patch conductor 20 from the −Y direction side when the antenna 1 transmits radio waves to the outside. Feeding power to the patch conductor 20 from the second power feed line 52 is referred to as 90 degree input. The second power feed line 52 feeds power from the patch conductor 20 to the external device or the like when the antenna 1 receives radio waves from the outside.

The antenna 1 does not necessarily include both the first power feed line 51 and the second power feed line 52. The antenna 1 needs to include the first power feed line 51 and/or the second power feed line 52.

The first connection conductor 61, the second connection conductor 62, the third connection conductor 63, and the fourth connection conductor 64 can be made of electrically conductive materials. Each of the first to fourth connection conductors 61 to 64 can be formed from the upper surface 11 to the lower surface 12 of the base 10.

As illustrated in FIG. 3, the first connection conductor 61 can electrically connect the peripheral conductor 30 and the first coupling conductor 41. The second connection conductor 62 can electrically connect the peripheral conductor 30 and the second coupling conductor 42. The third connection conductor 63 can electrically connect the peripheral conductor 30 and the third coupling conductor 43. The fourth connection conductor 64 can electrically connect the peripheral conductor 30 and the fourth coupling conductor 44. The first to fourth connection conductors 61 to 64 can be through-hole conductors. That is, the first to fourth connection conductors 61 to 64 each have a substantially cylindrical shape with a surface made of an electrically conductive material.

First Resonant State

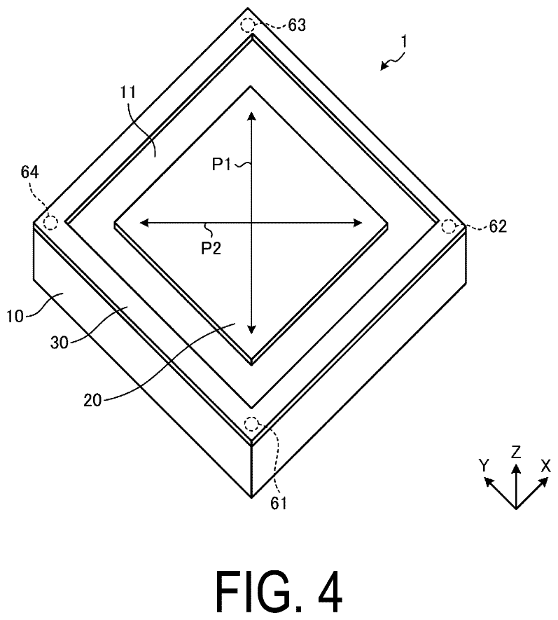

A first resonant state of the antenna according to the embodiment is described with reference to FIG. 4. FIG. 4 is a view for explaining a first resonant state of the antenna according to the embodiment.

The antenna 1 can resonate in a first frequency band along a first electrical current path. The antenna 1 can resonate in a second frequency band which is different from the first frequency band along a second electrical current path which is different from the first electrical current path.

The first frequency band and the second frequency band can include various frequency bands. For example, the first frequency band and the second frequency band can include frequency bands from several hundred MHz to several tens of GHz. Specifically, the first frequency band and the second frequency band can include the frequency bands of, for example, band 28, band 18, band 19, band 8, band 11, band 21, band 3, band 1, band 41, band 42, band n77, band n79, and band n257. The first frequency band and the second frequency band may be the same or different.

The first electrical current path is an electrical current path including the patch conductor 20, the peripheral conductor 30, the first coupling pair of the first coupling conductor 41 and the second coupling conductor 42, and the first coupling pair of the third coupling conductor 43 and the fourth coupling conductor 44. That is, the first electrical current path includes an electrical current path in which the electrical current flows in the X axis direction. The second electrical current path is an electrical current path including the patch conductor 20, the peripheral conductor 30, the second coupling pair of the first coupling conductor 41 and the fourth coupling conductor 44, and the second coupling pair of the second coupling conductor 42 and the third coupling conductor 43. That is, the second electrical current path includes an electrical current path in which the electrical current flows in the Y axis direction.

The antenna 1 resonates in the first frequency band along a first path P1. The first path P1 is an apparent electrical current path. The first path P1 appears by the electrical current flowing through the first electrical current path and the second electrical current path. For example, when the antenna 1 resonates in the first frequency band, the electrical current can flow through the patch conductor 20 from the first coupling conductor 41 toward the second coupling conductor 42 in the XY plane, while the electrical current can flow through the patch conductor 20 from the first coupling conductor 41 toward the fourth coupling conductor 44 in the XY plane. In addition, for example, when the antenna 1 resonates in the first frequency band, the electrical current can flow through the patch conductor 20 from the third coupling conductor 43 toward the fourth coupling conductor 44 in the XY plane, while the electrical current can flow through the patch conductor 20 from the third coupling conductor 43 toward the second coupling conductor 42 in the XY plane. The electrical current flowing between the coupling conductors 40 induces electromagnetic waves. The patch conductor 20 synthesizes and radiates the induced electromagnetic waves. The synthesized electromagnetic waves appear as if they are induced by a high-frequency electrical current flowing along the first path P1.

The antenna 1 resonates in a second frequency band along a second path P2. The second path P2 is an apparent electrical current path. The second path P2 appears by the current flowing through the first electrical current path and the second electrical current path. For example, when the antenna 1 resonates in the second frequency band, the electrical current can flow through the patch conductor 20 from the second coupling conductor 42 toward the first coupling conductor 41 in the XY plane, while the electrical current can flow through the patch conductor 20 from the second coupling conductor 42 toward the third coupling conductor 43 in the XY plane. In addition, for example, when the antenna 1 resonates in the second frequency band, the electrical current can flow through the patch conductor 20 from the fourth coupling conductor 44 toward the first coupling conductor 41 in the XY plane, and the electrical current can flow through the patch conductor 20 from the fourth coupling conductor 44 toward the third coupling conductor 43 in the XY plane. The electrical current flowing between the coupling conductors 40 induces electromagnetic waves. The patch conductor 20 synthesizes and radiates the induced electromagnetic waves. The synthesized electromagnetic waves appear as if they are induced by a high-frequency electrical current flowing along the second path P2.

The antenna 1 has a linearly symmetrical shape in the XY plane with respect to a straight line connecting the midpoints of two sides of the patch conductor 20 that are substantially parallel in the X direction. The antenna 1 has a linearly symmetrical shape in the XY plane with respect to a straight line connecting the midpoints of two sides of the patch conductor 20 that are substantially parallel in the Y direction. Since the antenna 1 has such a symmetrical structure, the length of the first path P1 and the length of the second path P2 can be equal. When the length of the first path P1 and the length of the second path P2 are equal, the first frequency band and the second frequency band can be equal. The length of the first path P1 and the length of the second path P2 may be different. In that case, the first frequency band and the second frequency band can be different.

The antenna 1 can be a filter for excluding the electromagnetic waves of frequency bands other than the first frequency band. When the antenna 1 as a filter includes the first power feed line 51 and the second power feed line 52, the power corresponding to the electromagnetic waves in the first frequency band is shared with an external device or the like via the first path P1 and the second path P2 through the first power feed line 51 and the second power feed line 52.

In the antenna 1, the first path P1 extends along a first diagonal direction of the base 10. The second path P2 extends along a second diagonal direction of the base 10. In other words, the first path P1 and the second path P2 are orthogonal to each other in the XY plane. The first path P1 and the second path P2 being orthogonal to each other in the XY plane generate orthogonal intersections of the electric field of the electromagnetic waves of the first frequency band radiated along the first path P1 and the electric field of the electromagnetic waves of the second frequency band radiated along the second path P2. When the first and second frequency bands are identical and the phase difference between the AC current apparently flowing in the first path P1 and the AC current apparently flowing in the second path P2 is 90 degrees, the antenna 1 can radiate circularly polarized waves of the first frequency band.

Specifically, in the antenna 1, the AC power of the first frequency band is supplied to the patch conductor 20 through each of the first power feed line 51 and the second power feed line 52. An equivalent magnitude of power is supplied from the first power feed line 51 to the patch conductor 20 and from the second power feed line 52 to the patch conductor 20. The phase difference between the AC power supplied from the first power feed line 51 to the patch conductor 20 and the AC power supplied from the second power feed line 52 to the patch conductor 20 is 90 degrees. For example, the phase of the AC power from the first power feed line 51 to the patch conductor 20 can be selected as appropriate at +90 degrees or −90 degrees relative to the phase of the AC power from the second power feed line 52 to the patch conductor 20. Thus, the radiation with right-turning or left-turning circular polarization can be selected as appropriate from the antenna 1.

The antenna 1 can resonate along the first path P1 even in a third frequency band that is smaller than the first frequency band. However, in the third frequency band, the electromagnetic waves induced by the electrical current flowing between the first and second coupling conductors 41 and 42 of the first coupling pair and the electromagnetic waves induced by the electrical current flowing between the first and fourth coupling conductors 41 and 44 of the second coupling pair cancel each other. Cancellation of the electromagnetic waves induced by the electrical current flowing between the coupling conductors 40 can decrease the intensity of radiation of the electromagnetic waves from the antenna 1, although the antenna 1 resonates.

The antenna 1 can resonate along the second path P2 even in a fourth frequency band smaller than the second frequency band. However, in the fourth frequency band, the electromagnetic waves induced by the electrical current flowing between the second and first coupling conductors 42 and 41 of the first coupling pair and the electromagnetic waves induced by the electrical current flowing between the second and third coupling conductors 42 and 43 of the second coupling pair cancel each other. Cancellation of the electromagnetic waves induced by the electrical current flowing between the coupling conductors 40 can decrease the intensity of radiation of the electromagnetic waves from the antenna 1, although the antenna 1 resonates.

Second Resonant State

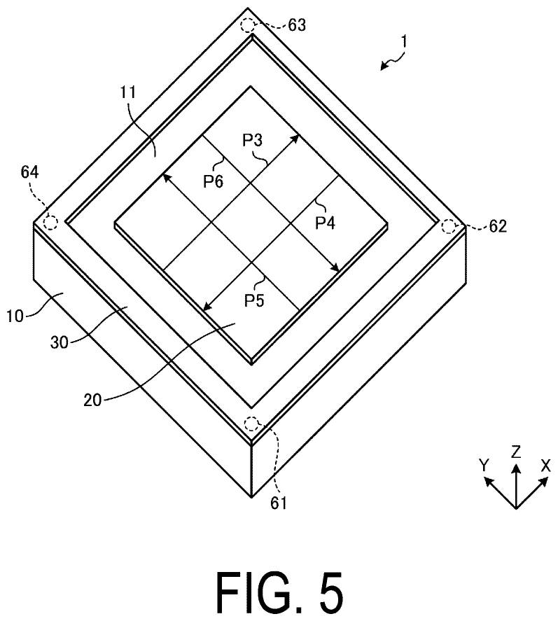

A second resonant state of the antenna according to the embodiment is described with reference to FIG. 5. FIG. 5 is a view for explaining the second resonant state of the antenna according to the embodiment.

The antenna 1 resonates in the first frequency band along a third path P3. The third path P3 is part of the first electrical current path. For example, when the antenna 1 resonates in the first frequency band, the electrical current can flow through the patch conductor 20 from the first coupling conductor 41 toward the second coupling conductor 42 in the XY plane. The electrical current flowing between the first coupling conductor 41 and the second coupling conductor 42 induces electromagnetic waves. That is, the electromagnetic waves are induced by the high-frequency electrical current flowing along the third path P3.

The antenna 1 resonates in the first frequency band along a fourth path P4. The fourth path P4 is part of the first electrical current path. For example, when the antenna 1 resonates in the first frequency band, the electrical current can flow through the patch conductor 20 from the third coupling conductor 43 toward the fourth coupling conductor 44 in the XY plane. The electrical current flowing between the third coupling conductor 43 and the fourth coupling conductor 44 induces electromagnetic waves. That is, the electromagnetic waves are induced by the high-frequency electrical current flowing along the fourth path P4.

The antenna 1 resonates in the second frequency band along a fifth path P5. The fifth path P5 is part of the second electrical current path. For example, when the antenna 1 resonates in the second frequency band, the electrical current can flow through the patch conductor 20 from the second coupling conductor 42 toward the third coupling conductor 43 in the XY plane. The electrical current flowing between the second coupling conductor 42 and the third coupling conductor 43 induces electromagnetic waves. That is, the electromagnetic waves are induced by the high-frequency electrical current flowing along the fifth path P5.

The antenna 1 resonates in the second frequency band along a sixth path P6. The sixth path P6 is part of the second electrical current path. For example, when the antenna 1 resonates in the second frequency band, the electrical current can flow through the patch conductor 20 from the fourth coupling conductor 44 toward the first coupling conductor 41 in the XY plane. The electrical current flowing between the fourth coupling conductor 44 and the first coupling conductor 41 induces electromagnetic waves. That is, the electromagnetic waves are induced by the high-frequency electrical current flowing along the sixth path P6.

The antenna 1 has a linearly symmetrical shape in the XY plane with respect to a straight line connecting the midpoints of two sides of the patch conductor 20 that are substantially parallel in the X direction. The antenna 1 has a linearly symmetrical shape in the XY plane with respect to a straight line connecting the midpoints of two sides of the patch conductor 20 that are substantially parallel in the Y direction. Since the antenna 1 has such a symmetric structure, the length of the third path P3 can be equal to the fourth path P4, and the length of the fifth path P5 can be equal to the length of the sixth path P6. Since the length of the third path P3 is equal to the length of the fourth path P4 and the length of the fifth path P5 is equal to the length of the sixth path P6, the first frequency band can be identical to the second frequency band. The length of the third path P3 or the fourth path P4 may be different from the length of the fifth path P5 or the sixth path P6. In that case, the first frequency band and the second frequency band are different.

The antenna 1 can be a filter for excluding the electromagnetic waves in frequency bands other than the first frequency band. When the antenna 1 as a filter includes the first power feed line 51, the power corresponding to the electromagnetic waves in the first frequency band is shared with an external device or the like via the third path P3 and the fourth path P4 through the first power feed line 51.

The antenna 1 can be a filter for excluding the electromagnetic waves in frequency bands other than the second frequency band. The antenna 1 as a filter includes the second power feed line 52, the power corresponding to the electromagnetic waves in the second frequency band is shared with an external device or the like via the fifth path P5 and the sixth path P6 through the second power feed line 52.

In the antenna 1, the direction of the electrical current of the third path P3 can be opposite to the direction of the electrical current of the fourth path P4. With the opposite directions of the electrical current in the third path P3 and the fourth path P4, the electromagnetic waves induced by the electrical current flowing through each path cancel each other. This can decrease the intensity of radiation of the electromagnetic waves from the antenna 1 in the first frequency band.

In the antenna 1, the direction of the electrical current of the fifth path P5 can be opposite to the direction of the electrical current of the sixth path P6. With the opposite directions of the electrical current of the fifth path P5 and the sixth path P6, the electromagnetic waves induced by the electrical current flowing through each path cancel each other. This can decrease the intensity of radiation of the electromagnetic waves from the antenna 1 in the second frequency band.

Radiation Characteristic

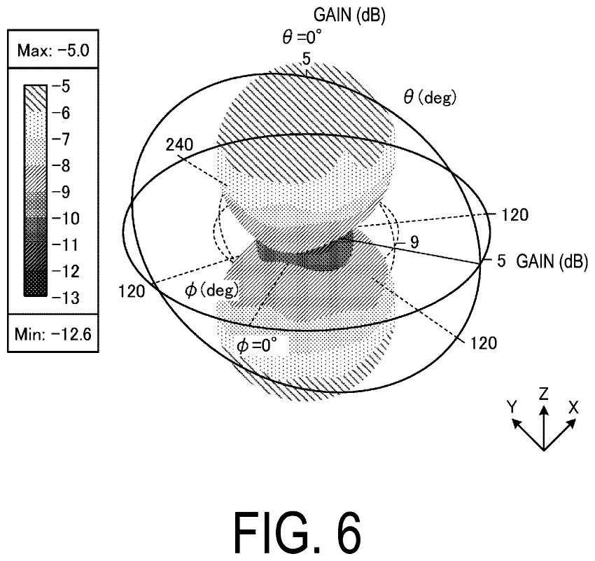

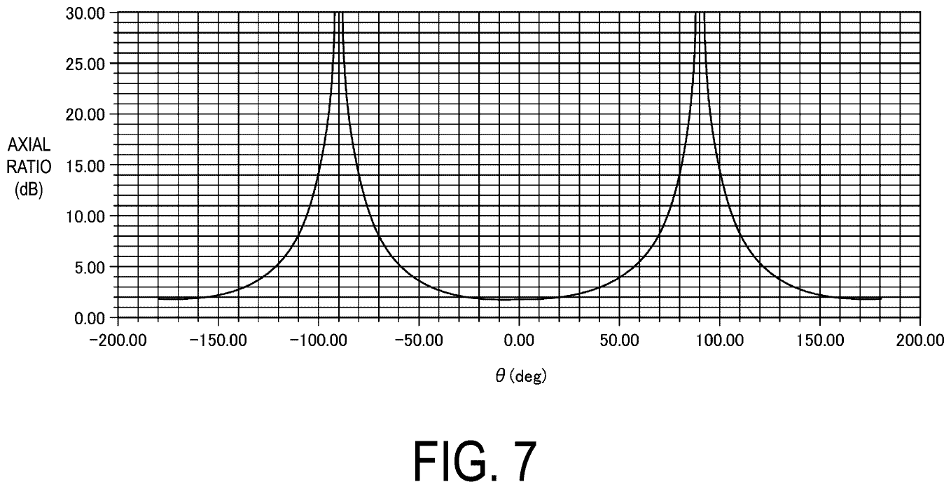

The radiation characteristic of the antenna according to the embodiment is described with reference to FIGS. 6 and 7. FIG. 6 is a view for explaining the radiation characteristic of the antenna in the azimuth direction and the elevation direction according to the embodiment. FIG. 7 is a graph for explaining the axial ratio in the elevation angle of the antenna according to the embodiment.

In FIG. 6, the XY plane represents the azimuth direction, and the YZ plane represents the elevation direction. The azimuth angle is denoted by φ, and the elevation angle is denoted by θ. In FIG. 6, the maximum gain is −5.0 dB, and the minimum gain is −12.6 dB. As illustrated in FIG. 6, the maximum value of the gain is indicated in the +Z axis direction and the −Z axis direction. That is, the antenna 1 emits electromagnetic waves that are circularly polarized in the +Z axis direction and the −Z axis direction. The antenna 1 outputs the circularly polarized waves from the upper surface 11 and the lower surface 12.

FIG. 7 illustrates the axial ratio of the antenna 1 in the θ direction. As illustrated in FIG. 7, the antenna 1 has a high axial ratio of about 1.8 dB at θ=0 degrees, that is, in the direction perpendicular to the XY plane. In addition, the antenna 1 has an axial ratio of 3.0 dB or less in a range from about −40 degrees to about 40 degrees. Thus, the antenna 1 has a high axial ratio over a wide range of about 80 degrees.

As described above, the antenna 1 of the present embodiment does not include the ground conductor formed over the entire lower surface 12 of the base 10. In the antenna 1 of the present embodiment, the peripheral conductor 30 formed on the upper surface 11 and surrounding the patch conductor 20 and the coupling conductors 40 formed on the lower surface 12 function as the ground. Thus, the present embodiment enables the antenna 1 to be thinner Since the antenna 1 of the present embodiment is about 0.5 mm thick, for example, it is suitable for attachment to a window glass or the like.

First Variation of Antenna

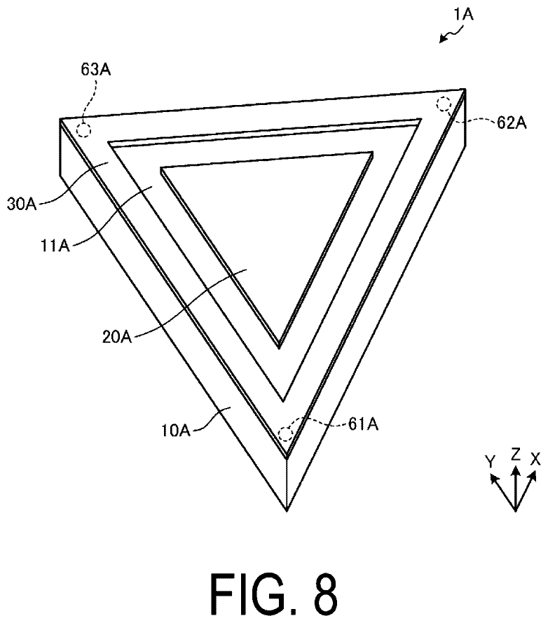

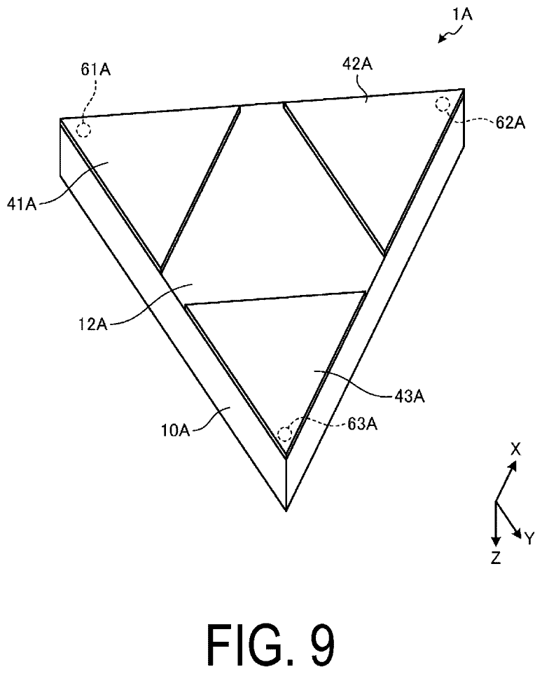

A first variation of the antenna according to the embodiment is described with reference to FIGS. 8 and 9. FIG. 8 is a schematic view of an antenna according to a first variation of the embodiment, when viewed from above. FIG. 9 is a schematic view of the antenna according to the first variation of the embodiment, when viewed from below.

As illustrated in FIGS. 8 and 9, an antenna 1A includes a base 10A, a patch conductor a peripheral conductor 30A, a first coupling conductor 41A, a second coupling conductor 42A, and a third coupling conductor 43A. The antenna 1A includes a first connection conductor 61A, a second connection conductor 62A, and a third connection conductor 63A. In FIGS. 8 and 9, no power feed line for feeding power to the patch conductor is illustrated.

The base 10A can be made of a dielectric material. The base 10A includes an upper surface 11A extending along the first plane and a lower surface 12A facing the upper surface 11A. For example, the base 10A can have a substantially triangular column shape when the patch conductor 20A has a substantially triangular shape.

The patch conductor 20A can be made of an electrically conductive material. The patch conductor 20A is formed on the upper surface 11A of the base 10A. The patch conductor 20A has a shape extending along the upper surface 11A. For example, the patch conductor 20A has a substantially triangular shape. The patch conductor 20A may have a substantially regular triangle shape or a substantially isosceles triangle shape.

The peripheral conductor 30A can be made of an electrically conductive material. The peripheral conductor 30A is formed on the upper surface 11A of the base 10A. The peripheral conductor 30A surrounds the patch conductor 20A. For example, the peripheral conductor 30A can be made of a frame formed along each side of the upper surface 11A of the base 10A. The peripheral conductor 30A can function as the ground for the antenna 1A.

A gap is formed between the patch conductor 20A and the peripheral conductor 30A. The patch conductor 20A is capacitively connected to the peripheral conductor 30A. The value of the capacitance generated between the patch conductor 20A and the peripheral conductor 30A changes depending on the size of the gap, a medium in the gap, and the facing areas. The size of the gap and the facing areas of the patch conductor 20A and the peripheral conductor 30A may be adjusted as appropriate in accordance with a desired resonant frequency of the antenna 1A. The medium in the gap between the patch conductor 20A and the peripheral conductor 30A may be adjusted in accordance with the desired resonant frequency of the antenna 1A. A capacitor may be provided to connect between the patch conductor 20A and the peripheral conductor 30A. The capacitance of the capacitor may be adjusted as appropriate in accordance with the desired resonant frequency of the antenna 1A.

The first coupling conductor 41A, the second coupling conductor 42A, and the third coupling conductor 43A can be made of electrically conductive materials. Each of the first coupling conductor 41A, the second coupling conductor 42A, and the third coupling conductor 43A is capacitively connected to the patch conductor 20A and the peripheral conductor 30A. The first coupling conductor 41A, the second coupling conductor 42A, and the third coupling conductor 43A are each formed at different corners in the lower surface 12A of the base 10A. The first coupling conductor 41A, the second coupling conductor 42A, and the third coupling conductor 43A may be referred to collectively as coupling conductors when no distinction is necessary. The antenna 1A has a first predetermined number of three coupling conductors 40A.

The coupling conductors 40A can each have a substantially triangular shape, for example. The coupling conductors 40A can be shaped differently from one another. The first coupling conductor 41A, the second coupling conductor 42A, and the third coupling conductor 43A are smaller than the patch conductor 20A.

The first coupling conductor 41A and the second coupling conductor 42A are part of a first group aligned in the first direction along the XY plane. The first coupling conductor 41A and the second coupling conductor 42A form a first coupling pair.

The first coupling conductor 41A and the third coupling conductor 43A are part of a second group aligned in a second direction different from the first direction along the XY plane. The first coupling conductor 41A and the third coupling conductor 43A form a second coupling pair.

The second coupling conductor 42A and the third coupling conductor 43A are part of a third group aligned in a third direction different from the first direction and the second direction along the XY plane. The second coupling conductor 42A and the third coupling conductor 43A form a third coupling pair.

Each of the coupling conductors 40A can be paired with another coupling conductor and belong to two groups among the first group, the second group, and the third group. For example, the first coupling conductor 41A can be paired with the second coupling conductor 42A and be part of the first group aligned in the first direction along the XY plane. The first coupling conductor 41A can be paired with the third coupling conductor 43A and be part of the second group aligned in the second direction along the XY plane.

The first coupling conductor 41A is electrically connected to the peripheral conductor 30A via the first connection conductor 61A. The second coupling conductor 42A is electrically connected to the peripheral conductor 30A via the second connection conductor 62A. The third coupling conductor 43A is electrically connected to the peripheral conductor via the third connection conductor 63A. The first connection conductor 61A, the second connection conductor 62A, and the third connection conductor 63A can be through-hole conductors.

The antenna 1A has a lineally symmetrical shape with respect to a perpendicular line drawn from one apex of the base 10A to the opposing bottom side. Thus, the antenna 1A can radiate the electromagnetic waves circularly polarized in the +Z axis direction and the −Z axis direction.

Second Variation of Antenna

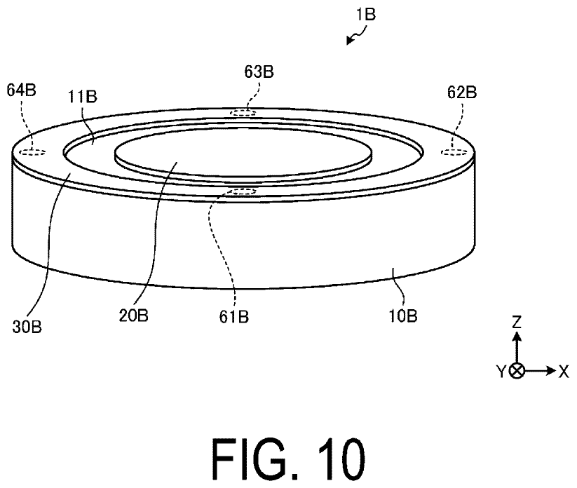

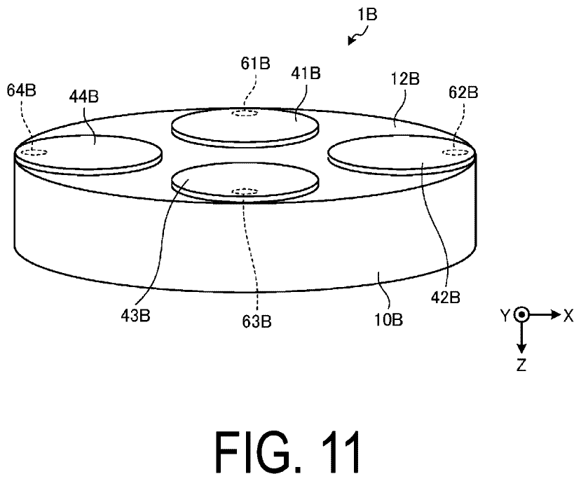

A second variation of the antenna according to the embodiment is described with reference to FIGS. 10 and 11. FIG. 10 is a schematic view of an antenna according to the second variation of the embodiment, when viewed from above. FIG. 11 is a schematic view of the antenna according to the second variation of the embodiment, when viewed from below.

As illustrated in FIGS. 10 and 11, an antenna 1B includes a base 10B, a patch conductor 20B, a peripheral conductor 30B, a first coupling conductor 41B, a second coupling conductor 42B, a third coupling conductor 43B, and a fourth coupling conductor 44B. The antenna 1B includes a first connection conductor 61B, a second connection conductor 62B, a third connection conductor 63B, and a fourth connection conductor 64B. In FIGS. 10 and 11, no power feed line for feeding power to the patch conductor 20B is illustrated.

The base 10B can be made of a dielectric material. The base 10B includes an upper surface 11B extending along a first plane and a lower surface 12B facing the upper surface 11B. For example, the base 10B can have a substantially circular column shape when the patch conductor 20B has a substantially circular shape.

The patch conductor 20B can be made of an electrically conductive material. The patch conductor 20B is formed on the upper surface 11B of the base 10B. The patch conductor 20B has a shape extending along the upper surface 11B. For example, the patch conductor 20B has a substantially circular shape.

The patch conductor 20B may have a substantially circular shape or a substantially elliptical shape.

The peripheral conductor 30B can be made of an electrically conductive material. The peripheral conductor 30B is formed on the upper surface 11B of the base 10B. The peripheral conductor 30B surrounds the patch conductor 20B. For example, the peripheral conductor 30B can be made of a frame formed along each side of the upper surface 11B of the base 10B. The peripheral conductor 30B can function as the ground for the antenna 1B.

A gap is formed between the patch conductor 20B and the peripheral conductor 30B. The patch conductor 20B is capacitively connected to the peripheral conductor 30B. The value of the capacitance generated between the patch conductor 20B and the peripheral conductor 30B changes depending on the size of the gap, a medium in the gap, and the facing areas. The size of the gap and the facing areas of the patch conductor 20B and the peripheral conductor 30B may be adjusted as appropriate in accordance with a desired resonant frequency of the antenna 1B. A capacitor may be provided to connect between the patch conductor 20B and the peripheral conductor 30B. The capacitance of the capacitor may be adjusted as appropriate in accordance with the desired resonant frequency of the antenna 1B.

The first coupling conductor 41B, the second coupling conductor 42B, the third coupling conductor 43B, and the fourth coupling conductor 44B can be made of electrically conductive materials. Each of the first coupling conductor 41B, the second coupling conductor 42B, the third coupling conductor 43B, and the fourth coupling conductor 44B is capacitively connected to the patch conductor 20B and the peripheral conductor 30B. The first coupling conductor 41B is located opposite to the third coupling conductor 43B on the Y-axis. The second coupling conductor 42B is located opposite to the fourth coupling conductor 44B on the X-axis. The first coupling conductor 41B, the second coupling conductor 42B, the third coupling conductor 43B, and the fourth coupling conductor 44B may be referred to collectively as coupling conductors 40B when no distinction is necessary. The antenna 1B has four coupling conductors 40B.

The coupling conductors 40B can have a substantially circular shape, for example. Each of the coupling conductors 40B may have different shapes. The first coupling conductor 41B, the second coupling conductor 42B, the third coupling conductor 43B, and the fourth coupling conductor 44B are smaller than the patch conductor 20B.

The first coupling conductor 41B and the third coupling conductor 43B are part of a first group aligned in the Y direction along the XY plane. The first coupling conductor 41B and the third coupling conductor 43B form a first coupling pair.

The second coupling conductor 42B and the fourth coupling conductor 44B are part of a second group aligned in the Y direction along the XY plane. The second coupling conductor 42B and the fourth coupling conductor 44B form a second coupling pair.

Each of the coupling conductors 40B can be paired with another coupling conductor and belong to both the first group and the second group. For example, the first coupling conductor 41B can be paired with the second coupling conductor 42B and be part of the first group aligned in the first direction along the XY plane. The first coupling conductor 41B can be paired with the fourth coupling conductor 44B and be part of the second group aligned in the second direction along the XY plane.

The first coupling conductor 41B is electrically connected to the peripheral conductor via the first connection conductor 61B. The second coupling conductor 42B is electrically connected to the peripheral conductor 30B via the second connection conductor 62B. The third coupling conductor 43B is electrically connected to the peripheral conductor via the third connection conductor 63B. The fourth coupling conductor 44B is electrically connected to the peripheral conductor 30B via the fourth connection conductor 64B. The first connection conductor 61B, the second connection conductor 62B, the third connection conductor 63B, and the fourth connection conductor 64B may be through-hole conductors.

The antenna 1B has a lineally symmetrical shape with respect to the line of diameter of the base 10B. Thus, the antenna 1B can radiate the electromagnetic waves circularly polarized in the +Z axis direction and the −Z axis direction.

Wireless Communication Module

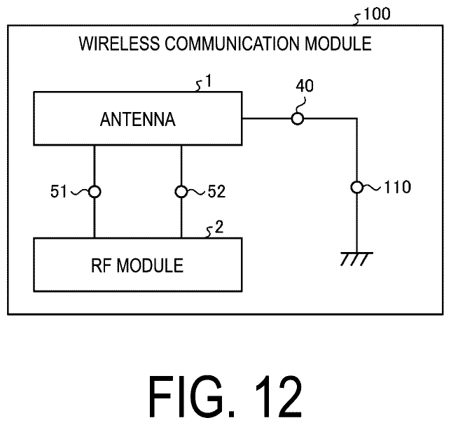

A wireless communication module according to the embodiment is described with reference to FIG. 12. FIG. 12 is a block diagram illustrating an example structure of a wireless communication module according to the embodiment.

As illustrated in FIG. 12, a wireless communication module 100 includes the antenna 1 according to the embodiment, a radio frequency (RF) module 2, and a circuit substrate 110.

The antenna 1 is located on the circuit substrate 110. The first power feed line 51 of the antenna 1 is electrically connected to the RF module 2 via the circuit substrate 110. The second power feed line 52 of the antenna 1 is electrically connected to the RF module 2 via the circuit substrate 110. The coupling conductors 40 of the antenna 1 are electrically connected to the ground conductor of the circuit substrate 110.

The antenna 1 may include only the first power feed line 51. With the antenna 1 having only one first power feed line 51, the structure of the circuit substrate 110 is changed as appropriate. For example, the RF module 2 may have one connection terminal. For example, the circuit substrate 110 may include a single electrically conductive line that connects the connection terminal of the RF module 2 and the power feed line of the antenna 1.

The antenna 1 can be made integrally with the circuit substrate 110. With the antenna 1 being formed integrally with the circuit substrate 110, the coupling conductors 40 of the antenna 1 can be integrally formed with the ground conductor of the circuit substrate 110.

The RF module 2 regulates power to be fed to the antenna 1. The RF module 2 can modulate a baseband signal and supply it to the antenna 1. The RF module 2 can modulate an electrical signal received by the antenna 1 into a baseband signal.

The antenna 1 has a small change in the resonant frequency caused by the conductors on the circuit substrate 110 side. The wireless communication module 100 can reduce the influence of the external environment by providing the antenna 1.

The present embodiment enables the antenna 1 to be thinner. Accordingly, the wireless communication module 100 can also be thinner.

Wireless Communication Device

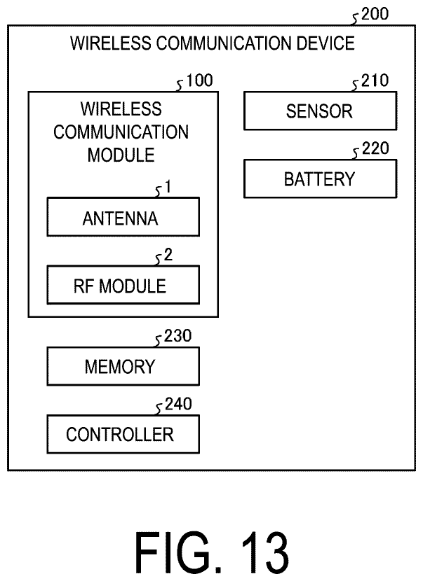

A wireless communication device according to the embodiment is described with reference to FIG. 13. FIG. 13 is a block diagram illustrating an example structure of a wireless communication device according to the embodiment.

As illustrated in FIG. 13, a wireless communication device 200 includes the wireless communication module 100, a sensor 210, a battery 220, a memory 230, and a controller 240.

The sensor 210 includes various sensors. Examples of the sensor 210 may include a velocity sensor, a vibration sensor, an acceleration sensor, a gyroscopic sensor, a rotation angle sensor, an angular velocity sensor, a geomagnetic sensor, a magnet sensor, a temperature sensor, a humidity sensor, an air pressure sensor, an optical sensor, an illuminance sensor, a UV sensor, a gas sensor, a gas concentration sensor, an atmosphere sensor, a level sensor, an odor sensor, a pressure sensor, a pneumatic sensor, a contact sensor, a wind sensor, an infrared sensor, a motion sensor, a displacement sensor, an image sensor, a weight sensor, a smoke sensor, a leakage sensor, a vital sensor, a battery level sensor, an ultrasound sensor, and the like. The sensor 210 may include a receiver for receiving signals from a global positioning system (GPS).

The battery 220 supplies power to the wireless communication module 100. The battery 220 can supply power to at least one of the sensor 210, the memory 230, and the controller 240. The battery 220 can include a primary battery and/or a secondary battery. The negative pole of the battery 220 can be electrically connected to the ground terminal of the circuit substrate 110.

The memory 230 can include, for example, a semiconductor memory. The memory 230 can function as a work memory for the controller 240. The memory 230 can be included in the controller 240. The memory 230 stores programs describing processing contents for implementing the functions of the wireless communication device 200, information used in the wireless communication device 200, and the like.

For example, the controller 240 can include a processor. The controller 240 may include one or more processors. The processor may include a general-purpose processor that reads a specific program in order to execute a specific function, and a dedicated processor dedicated to specific processing. A dedicated processor may include an application-specific IC. The application-specific IC is also referred to as an Application Specific Integrated Circuit (ASIC). The processor may include a programmable logic device. The programmable logic device is also called a Programmable Logic Device (PLD). The PLD may include a Field-Programmable Gate Array (FPGA). The controller 240 may be any of a System-on-a-Chip (SoC) and a System In a Package (SiP) in which one or a plurality of processors cooperate. The controller 240 may store, in the memory 230, various types of information or programs and the like for causing the components of the wireless communication device 200 to operate.

The controller 240 can generate a transmission signal to be transmitted from the wireless communication device 200. The controller 240 may acquire measurement data from the sensor 210, for example. The controller 240 may generate a transmission signal based on the measurement data. The controller 240 may transmit a baseband signal to the RF module 2 of the wireless communication module 100.

In the present disclosure, the thickness of the wireless communication module 100 can be reduced. Accordingly, the thickness of the wireless communication device 200 can also be reduced.

The configurations according to the present disclosure are not limited only to the embodiments described above, and some variations or changes can be made. For example, the functions and the like included in each of the components can be rearranged as long as they are logically consistent, and a plurality of components or the like can be combined into one or divided.

1. An antenna, comprising:
a base having a first surface extending along a first plane;
a patch conductor disposed on the first surface;
a peripheral conductor disposed on the first surface and surrounding the patch conductor;
a first predetermined number of coupling conductors capacitively connecting the patch conductor and the peripheral conductor, the first predetermined number being at least three; and
a first power feed line connected to the patch conductor, wherein
among the first predetermined number of coupling conductors,
any two of the coupling conductors form a first coupling pair composing a part of a first coupling group aligned in a first direction along the first plane, and
any two of the coupling conductors form a second coupling pair composing a part of a second coupling group aligned in a second direction intersecting the first direction along the first plane,
the antenna is configured to resonate in a first frequency band along a first electrical current path, and is configured to resonate in a second frequency band along a second electrical current path,
the first electrical current path comprises the patch conductor, the peripheral conductor, and the first coupling pair, and
the second electrical current path comprises the patch conductor, the peripheral conductor, and the second coupling pair.

2. The antenna according to claim 1, wherein
the first frequency band is identical to the second frequency band.

3. The antenna according to claim 1, wherein
the first frequency band is different from the second frequency band.

4. The antenna according to claim 1, wherein
the patch conductor and the first predetermined number of coupling conductors are configured to face each other in a direction intersecting the first plane and to be capacitively connected.

5. The antenna according to claim 1, wherein
The peripheral conductor and the first predetermined number of coupling conductors are configured to face each other in a direction intersecting the first plane and to be capacitively connected.

6. The antenna according to claim 1, wherein
the patch conductor has a length along the first direction which is different from a length along the second direction.

7. The antenna according to claim 1, wherein
the first power feed line is configured to induce an electrical current in the first electrical current path.

8. The antenna according to claim 7, wherein
the first power feed line is configured to induce an electrical current in the second electrical current path.

9. The antenna according to claim 1, wherein
the antenna comprises a second power feed line connected to the patch conductor at a position different from the first power feed line.

10. The antenna according to claim 9, wherein
the second power feed line is configured to induce an electrical current in the second electrical current path.

11. A wireless communication module comprising:
the antenna according to claim 1; and
an RF module configured to be electrically connected to the first power feed line.

12. A wireless communication device comprising:
the wireless communication module according to claim 11; and
a battery configured to supply power to the wireless communication module.
